(19) United States
(12) Patent Application Publication
(10) Pub. No.: US 2015/0034778 A1
(43) Pub. Date: Feb. 5, 2015

(54) HOLDER STAND

(71) Applicant: CHEN-SOURCE INC., Taoyuan County (TW)

(72) Inventors: Chung-Yi LIN, Taoyuan County (TW); Chun-Wei LIN, Taoyuan County (TW)

(73) Assignee: CHEN-SOURCE INC., Taoyuan County (TW)

(21) Appl. No.: 13/955,497

(22) Filed: Jul. 31, 2013

(51) Int. Cl. G06F 1/16

(52) U.S. Cl. CPC G06F 1/1613
USPC 248/124.1; 248/121

(57) ABSTRACT

A holder stand includes an adjustable support arm assembly, a holder member pivotally connected to one end of the support arm assembly by a ball-and-socket joint for holding a mobile electronic device, a base member defining a position-limited groove and two retaining holes at two opposite sides of the position-limited groove, and a mating connection block assembly including a housing pivotally connected to an opposite end of the support arm assembly and detachably insertable into the position-limited groove of the base member, two spring members mounted in the housing and two press members coupled to two opposite lateral sides of the housing and respectively forced by the spring members into engagement with the retaining holes of the base member to releasably lock the mating connection block assembly to the base member.

### BACKGROUND OF TILE INVENTION

1. Field of the Invention

The present invention relates to mobile electronic device support stands, and more particularly to a holder stand for mobile electronic device, which facilitates mounting and dismounting, allows adjustment of the viewing angle of the loaded mobile electronic device, and assures a high level of stability.

2. Description of the Related Art

With fast development of electronic and multimedia technologies, advanced and sophisticated smart phone, tablet computer, PDA and many other mobile electronic devices have been continuously created and appeared on the market. These mobile electronic devices have the characteristics of small size, light weight and high mobility. With continuous creation of hardware and software functions, mobile electronic devices are widely used in our daily life for different purposes.

Further, an electronic system equipped with a display screen is normally placed on the top of a table. When adjusting the viewing angle of the display screen, the user may lift the electronic system from the top of the table and bias the angle of the electronic system, and then place the electronic system on the top of the table again. An adjustable stand may be used to support an electronic system on the top of a table. By means of biasing the multiple arm components of the support arm of the adjustable stand, the viewing angle of the supported electronic system is adjusted. However, this design of adjustable stand is simply designed for placing on a table or platform. It is not suitable for use in particular places (such as kitchen, bathroom, bed, etc.). When using an electronic system or mobile electronic device in a small place that does not allow installation of a table or like means, the user can simply hold the electronic system or mobile electronic device by hand or put it on the laps. It is not comfortable to use the electronic system or mobile electronic device in this manner. Further, there are wall-mount holder stands mountable to a vertical support wall to hold a mobile electronic device for operation. However, these wall-mount holder stands do not facilitate adjustment of the viewing angle of the supported mobile electronic device. When going to adjust the viewing angle of the supported mobile electronic device, the user needs to dismount the base member from the vertical support wall with a tool. When dismounting the base member from the vertical support wall, the wall-mount holder stand can be damaged accidentally. An improvement in this regard is desired.

### SUMMARY OF THE INVENTION

The present invention has been accomplished under the circumstances in view. It is the main object of the present invention to provide a holder stand for holding a mobile electronic device, which facilitates mounting and dismounting, allows adjustment of the viewing angle of the loaded mobile electronic device, and assures a high level of stability.

To achieve this and other objects of the present invention, a holder stand of the present invention comprises a support arm assembly, a holder member, a mating connection block assembly, and a base member. The support arm assembly comprises a plurality of arm components, a pivot joint coupled between each two arm components to connect the arm components in series, a first connector located at one end of the series of arm components, and a second connector located at an opposite end of the series of arm components. The holder member is pivotally connected to the first connector of the support arm and adapted to hold a mobile electronic device, comprising a plurality of corner lugs respectively located at corners of a front wall thereof for securing the loaded mobile electronic device. The mating connection block assembly is pivotally connected to the second connector of the support arm assembly, comprising a housing, two press members and two spring members. The housing comprises an accommodation chamber defined therein for accommodating the press members and the spring members, two protruding mounting portions symmetrically located at two opposite lateral sides thereof and two openings respectively defined in two opposite sidewalls thereof corresponding to the protruding mounting portions. The spring members are transversely mounted in the accommodation chamber and aligned in line. The press member are respectively supported on the spring members, each comprising a finger knob extending out of one respective opening of the housing and a protruding block located at a bottom side relative to the finger knob. The base member comprises two guide rails transversely disposed at a top wall thereof, a position-limited groove defined between the two guide rails for receiving the housing of the mating connection block assembly, and a retaining hole defined in each guide rail and facing toward the position-limited groove for receiving the protruding block of one respective press member to secure the mating connection block assembly to the base member.

Further, the position-limited groove of the base member is so configured that when the housing of the mating connection block assembly is inserted into the position-limited groove of the base member, the press members will be forced inwardly toward each other against the spring members, enabling the protruding blocks of the press members to be respectively forced into the retaining holes of the base member. Thus, the mating connection block assembly is locked to the base member positively. Further, by means of pressing the press members to disengage the respective protruding blocks from the respective retaining holes of the base member, the mating connection block assembly is unlocked from the base member.

Further, the base member has a certain weight and a large surface for positioning on a flat surface of a table or platform stably. Further, the user can bias the holder member relative to the first connector of the support arm assembly, bias each arm component relative to one respective pivot joint, or bias the support arm assembly relative to the base member, adjusting the viewing angle of the loaded mobile electronic device.

Further, the base member further can be configured to provide a plurality of mounting through holes for the mounting of respective fastening members to affix the base member to a house wall, office partition wall, cabinet wall, furniture wall, or any other vertical support wall.

### BRIEF DESCRIPTION OF THE DRAWINGS

FIG. 1 is an oblique top elevational view of a holder stand in accordance with the present invention.

FIG. 2 is an exploded view of the holder stand in accordance with the present invention.

FIG. 3 corresponds to FIG. 2 when viewed from another angle.

FIG. 4 is an exploded view of the mating connection block assembly of the holder stand in accordance with the present invention.

FIG. 5 corresponds to FIG. 4 when viewed from another angle.

FIG. 6 is a schematic exploded view of a part of the present invention, illustrating the relationship between the mating connection block assembly and the base member.

FIG. 7 corresponds to FIG. 6, illustrating the housing of the mating connection block assembly inserted into the position-limited groove of the base member.

FIG. 8 corresponds to FIG. 7, illustrating the mating connection block assembly locked to the base member.

FIG. 9 is a schematic applied view of the holder stand in accordance with the present invention.

FIG. 10 is an exploded view of an alternate form of the holder stand in accordance with the present invention.

### DETAILED DESCRIPTION OF THE PREFERRED EMBODIMENT

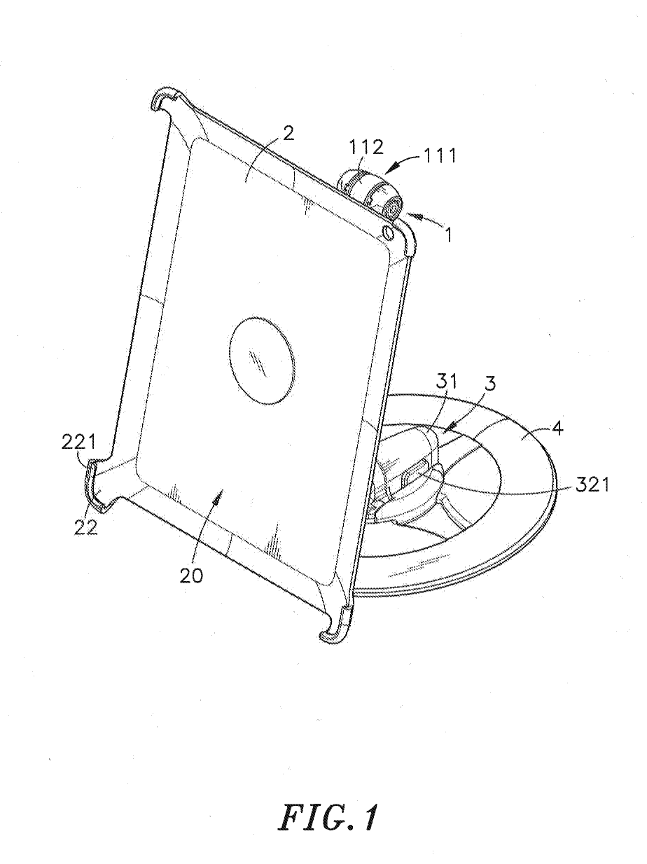

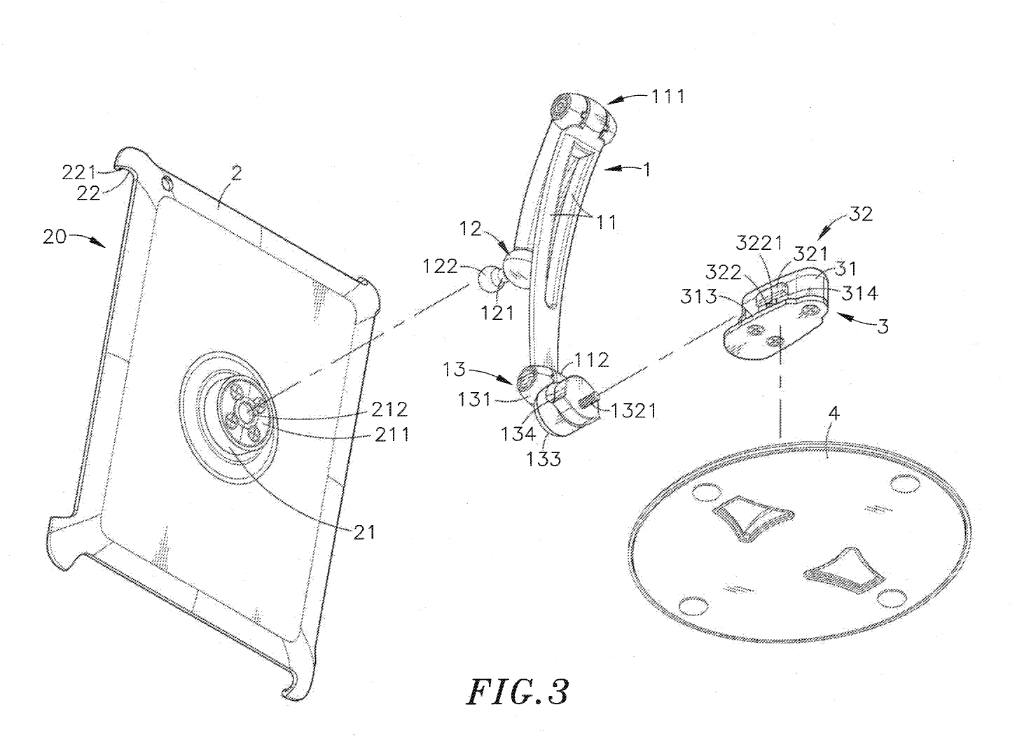

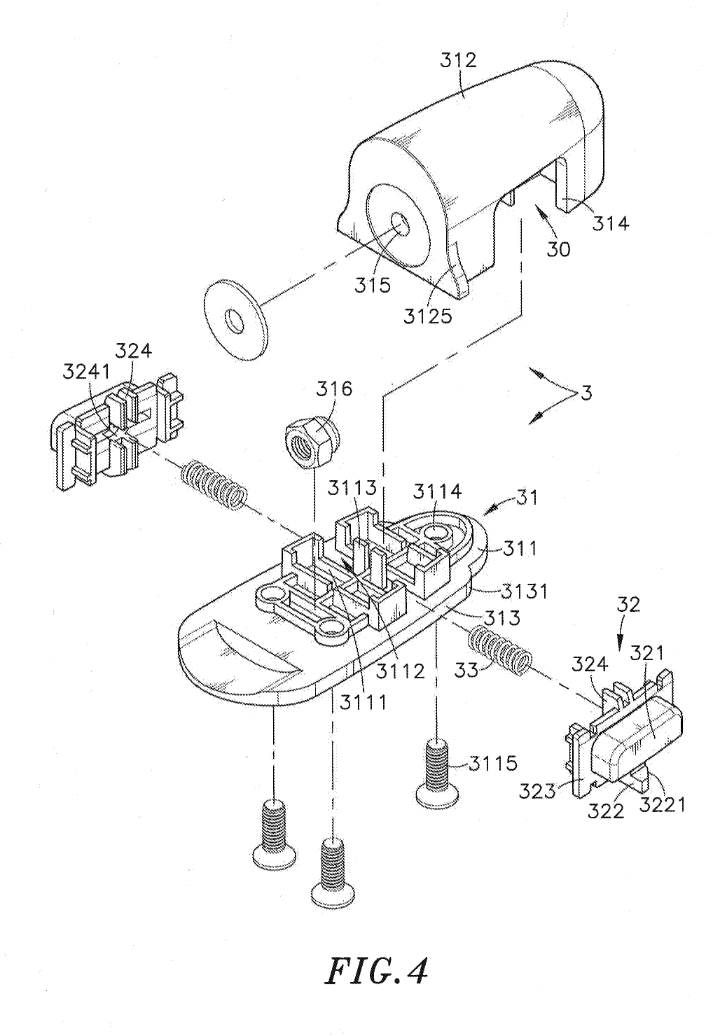

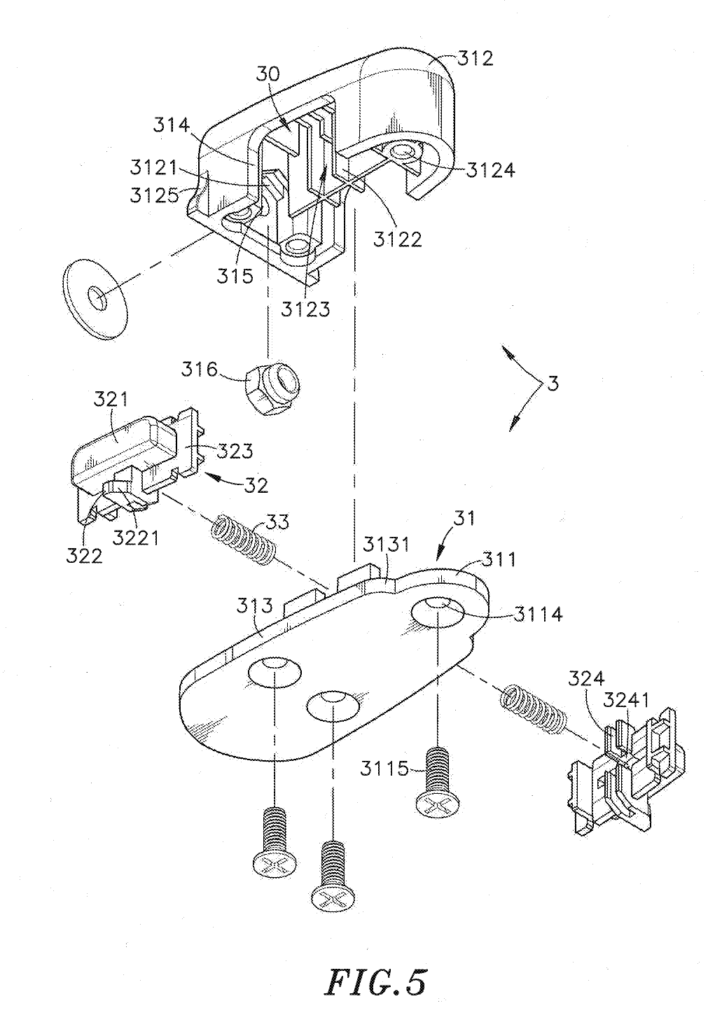

Referring to FIGS. 1-5, a holder stand in accordance with a first embodiment of the present invention is shown. The holder stand comprises a support arm assembly 1, a holder member 2, a mating connection block assembly 3, and a base member 4.

The support arm assembly 1 comprises a plurality of arm components 11, a pivot joint 111 coupled between each two arm components 11 to connect the arm components 11 in series, a first connector 12 located at one end of the series of arm components 11, a connection rod 112 and a stop block 113 located at an opposite end of the series of arm components 11, and a second connector 13 pivotally connected to the connection rod 112 above the stop block 113. The first connector 12 comprises a neck 121 perpendicularly outwardly extended from the periphery thereof, and a ball 122 located at the distal end of the neck 121. The second connector 13 comprises a plurality of support bars 131 vertically disposed at a top side thereof and pivotally coupled to the connection rod 112, an axle hole 130 transversely disposed at a middle part thereof at a bottom side relative to the support bars 131, an axle rod 132 mounted in the axle hole 130 and comprising a male screw portion 1321 that suspends outside the axle hole 130, a vertical cut plane 133 located at a front side thereof around the axle hole 130 for stopping against the stop block 113, and two protruding stop portions 134 bilaterally disposed at a rear side thereof.

The holder member 2 is flat panel member comprising a plurality of corner lugs 22 respectively located at corners of a front wall thereof, an accommodation space 20 defined in the front wall and surrounded by the corner lugs 22 for holding a mobile electronic device 5, and a connector 21 located at the center of an opposite back wall thereof and pivotally coupled to the first connector 12 of the support arm assembly 1. Each corner lug 22 defines a hook portion 221 at a top side thereof for hooking on the loaded mobile electronic device 5. The connector 21 comprises a socket 211 for accommodating the ball 122 of the first connector 12, and a front socket hole 212 defined in the front center of the socket 211 for the passing of the neck 121 of the first connector 12.

The mating connection block assembly 3 is pivotally connected to the second connector 13 of the support arm assembly 1, comprising a housing 31, two press members 32 symmetrically mounted in two opposite lateral sides of the housing 31, and two spring members 33 mounted within the housing 3 to support the press members 32 respectively. The housing 31 comprises a bottom shell 311, a top cover shell 312 covering the bottom shell 311, and an accommodation chamber 30 defined in between the bottom shell. 311 and the top cover shell 312 for accommodating the press members 32 and the spring members 33. The bottom shell 311 comprises two protruding mounting portions 313 symmetrically located at two opposite lateral sides thereof, and an abutment surface 3131 located at a rear side of each of the two protruding mounting portions 313. The top cover shell 312 comprises two openings 314 respectively defined in two opposite sidewalls thereof corresponding to the protruding mounting portions 313 of the bottom shell 311. The press members 32 are bilaterally accommodated in the accommodation chamber 30 and transversely slidably supported on the protruding mounting portions 313, each comprising a finger knob 321 extending out of one respective opening 314 of the top cover shell 312, a protruding block 322 located at a bottom side relative to the finger knob 321, and a bevel edge 3221 located at a rear side of the protruding block 322. The two spring members 33 are bilaterally mounted in the accommodation chamber 30 inside the housing 3 and respectively stopped against the press members 32 to impart an outward pressure to the respective press members 32.

The bottom shell 311 further comprises a plurality of partition blocks 3111 symmetrically arranged at a top wall thereof, two transverse sliding ways 3112 symmetrically defined between the partition blocks 3111 and aligned in line, two locating rods 3113 respectively disposed in the transverse sliding ways 3112 near a middle part of the top wall of the bottom shell 311 for supporting the spring members 33, and a plurality of vertical countersunk holes 3114 for the mounting of respective mounting screws 3115 to affix the bottom shell 311 to the top cover shell 312. The top cover shell 312 further comprises a through hole 315 located at a front side thereof for receiving the axle rod 132 of the second connector 13 of the support arm assembly 1, a locating groove 3121 defined therein, a screw nut 316 mounted in the locating groove 3121 and threaded onto the male screw portion 1321 of the axle rod 132.

The top cover shell 312 further comprises a plurality of partition plates 3122 disposed therein and respectively attached to the partition blocks 3111 of the bottom shell 311, two sliding ways 3123 defined between the partition plates 3122 and corresponding to the transverse sliding ways 3112 of the bottom shell 311, a plurality of mounting screw holes 3124 respectively aimed at the vertical countersunk holes 3114 of the bottom shell 311 for receiving the respective mounting screws 3115, and two baffles 3125 respectively extended from the two opposite sidewalk thereof at a front side relative to the openings 314. Each press member 32 further comprises a body panel 323 carrying the finger knob 321 and stoppable at an inner surface of one respective sidewall of the top cover shell 312 within the respective opening 314 of the top cover shell 312, a plurality of guide plates 324 perpendicularly extended from a back surface of the body panel 323 opposite to the finger knob 321 and slidably inserted into one respective transverse sliding way 3112 of the bottom shell 311 and one respective sliding way 3123 of the top cover shell 312, and a locating hole 3241 located at the back surface of the body panel 323 and adapted to accommodate one end of one respective spring member 33.

The base member 4 comprises two guide rails 411 transversely disposed at a top wall thereof, a position-limited groove 41 defined between the two guide rails 411, a retaining hole 412 defined in each guide rail 411 and facing toward the position-limited groove 41, a stop flange 4111 located at a rear side of each guide rail 411 and facing toward the position-limited groove 41, and a bearing edge 4112 located at a front side of each guide rail 411.

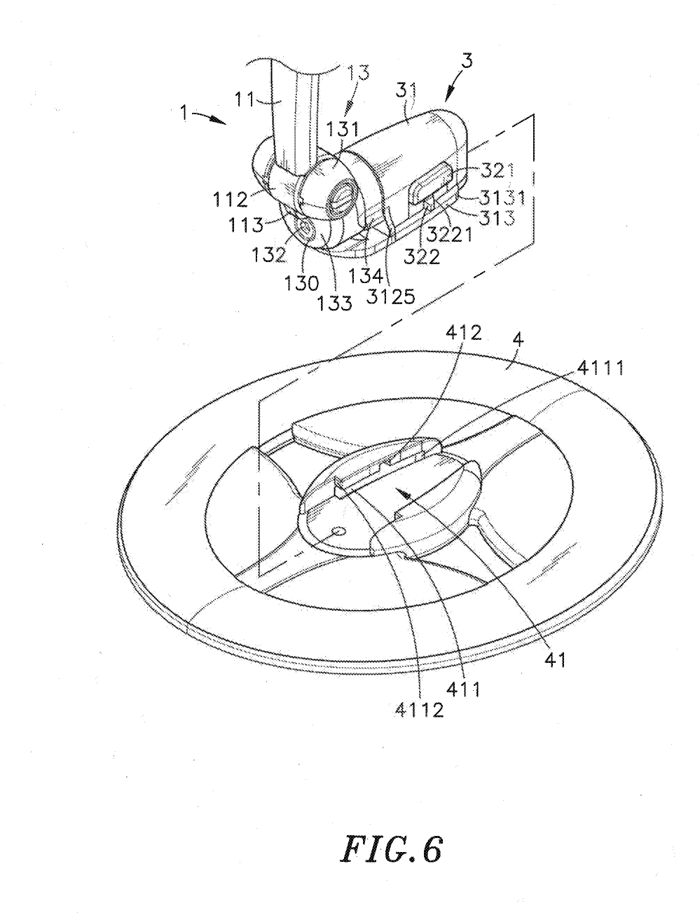

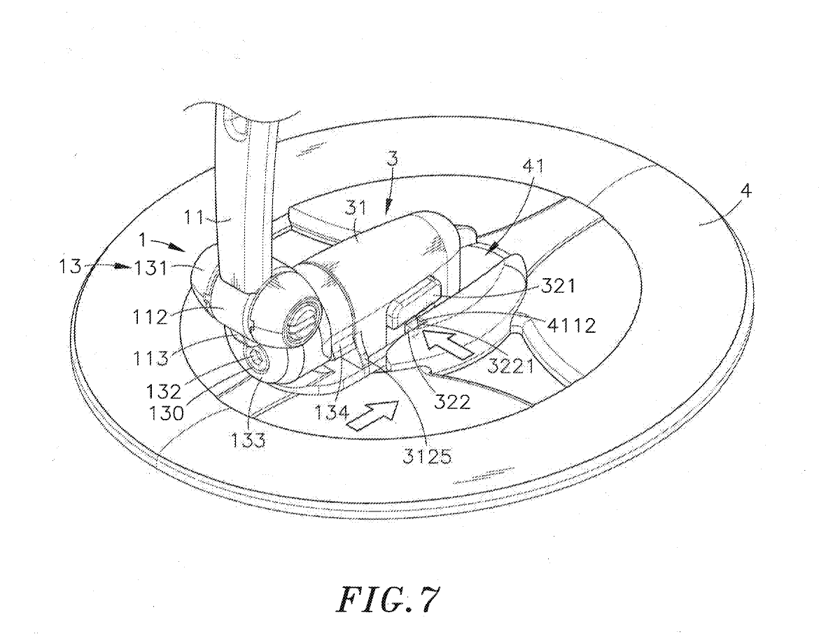

Referring to FIGS. 6-7, a mobile electronic device 5 mountable in the accommodation space 20 of the holder member 2 can be, for example, an electronic book, smart phone or LCD panel. After insertion of a mobile electronic, device 5 in the accommodation space 20 of the holder member 2, the hook portions 221 of the corner lugs 22 are respectively hooked on corners of the mobile electro ic device 5, holding it firmly at the holder member 2.

Further, when fastening the mating connection block assembly 3 to the base member 4, insert the housing 31 of the mating connection block assembly 3 into the position-limited groove 41 of the base member 4 to move the two protruding mounting portions 313 of the bottom shell 311 of the housing 31 along the respective guide rails 411 of the base member 4 and to further abut the bevel edges 3221 of the protruding blocks 322 against the respective bearing edges 4112. When continuously pushing the housing 31 of the mating connection block assembly 3 toward the inside of the position-limited groove 41 of the base member 4 to impart a pressure to the bevel edges 3221 of the protruding blocks 322 against the respective bearing edges 4112, the press members 32 are forced in direction toward each other to compress the spring members 33.

When continuously moving the housing 31 toward the inside of the position-limited groove 41 of the base member 4 at this time, the protruding blocks 322 will be moved over the respective bearing edges 4112 toward the inside of the position-limited groove 41 to the extent where the abutment surfaces 3131 of the bottom shell 311 are respectively stopped at the stop flanges 4111 of the base member 4, the baffles 3125 of the top cover shell 312 are respectively stopped at the bearing edges 4112 of the base member 4, and the protruding blocks 322 are respectively forced by the respective spring members 33 into the retaining holes 412 of the base member 4 to lock the housing 31 to the base member 4 positively, prohibiting displacement of the mating connection block assembly 3 relative to the base member 4. This mounting procedure is easy, assuring a high level of stability.

When using the holder stand, place the base member 4 on the flat surface of a table or platform. Subject to the heavy weight and large surface area of the base member 4, the base member 4 is used as a carrier bearing disk to support the loaded mobile electronic device 5 steadily on the table or platform. When the user wishes to adjust the angular position of the mobile electronic device 5, bias each two adjacent arm components 11 relative to the respective pivot joint 111 to change the contained angle between these two adjacent arm components 11, and/or rotate the holder member 2 relative to the support arm assembly 1 to change the angular position of the ball 122 of the first connector 12 of the support arm assembly 1 in the front socket hole 212 in the socket 211 of the connector 21 of the holder member 2, and/or bias the support arm assembly 1 to change the forward-backward angular position of the connection rod 112 relative to the second connector 13, preventing falling of the arm components 11 of the support arm assembly 1, and/or rotate the axle rod 132 of the second connector 13 leftward or rightward relative to the housing 31 of the mating connection block assembly 3. When biasing the connection rod 112 forwardly relative to the second connector 13 to the extent, the stop block 113 will be stopped at the vertical cut plane 133 of the second connector 13. When rotating the axle rod 132 of the second connector 13 leftward or rightward relative to the housing 31 of the mating connection block assembly 3 to the extent, the left or right protruding stop portion 134 of the second connector 13 will be stopped at the surface of the bottom shell 311 of the housing 1. Thus, the user can conveniently adjust the loaded mobile electronic device 5 to the optimal viewing angle.

When the user wishes to detach the mating connection block assembly 3 from the base member 4, press the finger knobs 321 of the press members 3 with the fingers to compress the spring members 33 and to further disengage the protruding blocks 322 of the press members 3 from the respective retaining holes 412 of the base member 4. After disengagement of the protruding blocks 322 of the press members 3 from the respective retaining holes 412 of the base member 4, the housing 31 and the base member 4 are unlocked, allowing detachment of the mating connection block assembly 3 out of the position-limited groove 41 of the base member 4.

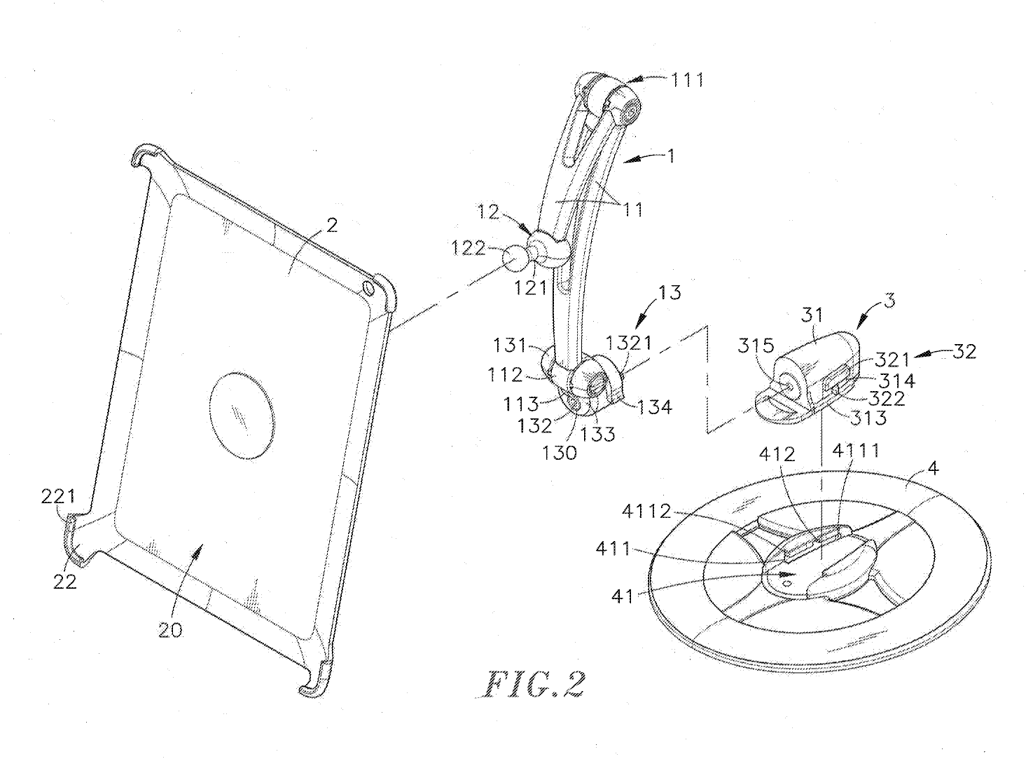

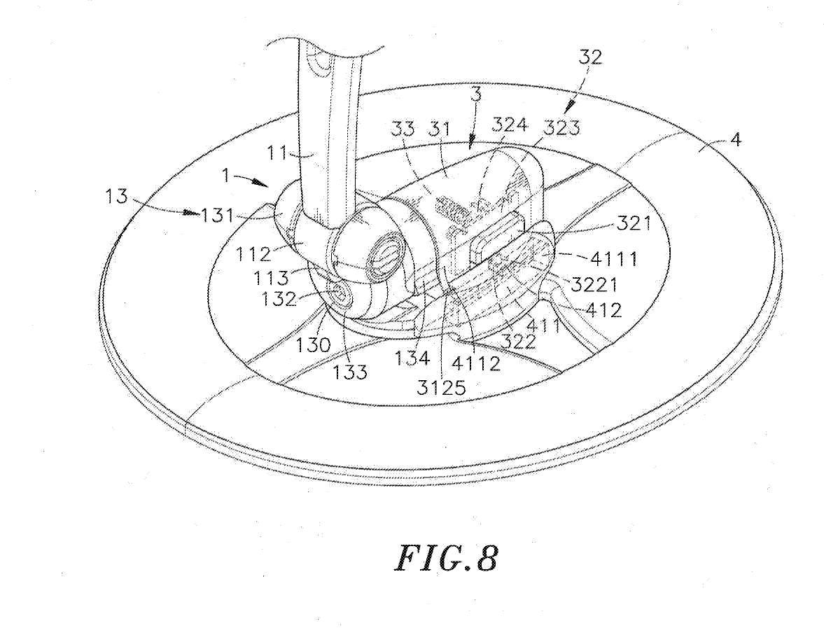

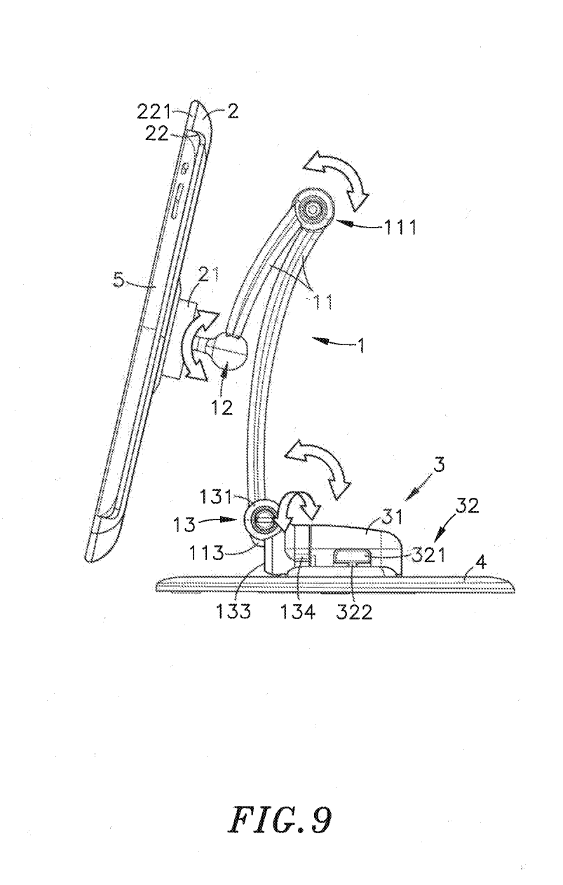

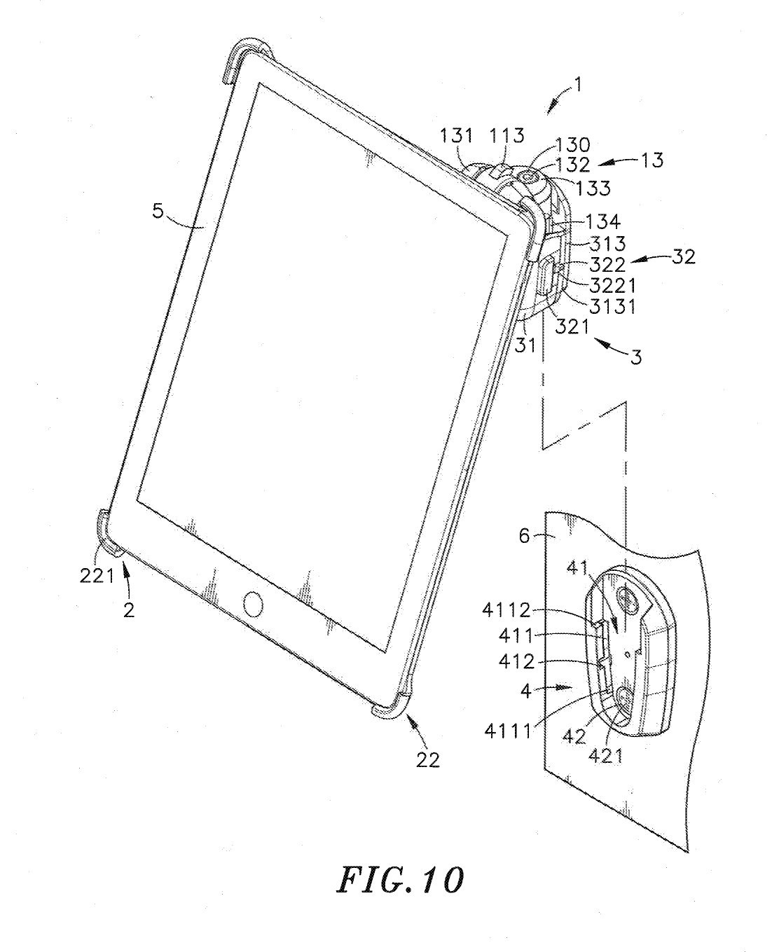

Referring to FIGS. 8-10 and FIGS. 2 and 4 again, the base member 4 can be configured for wall mounting, having a plurality of mounting through holes 42 for the mounting of fastening members 421 (such as screws, rivets, expansion screws, etc.) to affix the base member 4 to a house wall, office partition wall, cabinet wall, furniture wall, or any other vertical support wall 6.

After the base member 4 is affixed to a vertical support wall 6, the housing 31 of the mating connection block assembly 3 is vertically downwardly inserted into the position-limited groove 41 of the base member 4 to move the two protruding mounting portions 313 of the bottom shell 311 of the housing 31 along the respective guide rails 411 of the base member 4 and to further force the press members 32 against the respective spring members 33 and move the protruding blocks 322 into the retaining holes 412 of the base member 4, and thus the housing 31 and the base member 4 are locked. By means of pressing the press members 32 with the fingers, the user can conveniently disengage the protruding blocks 322 from the respective retaining holes 412 and then detach the housing 31 out of the position-limited groove 41 of the base member 4. Thus, the user can fasten the mating connection block assembly 3 to the base member 4 or detach the mating connection block assembly 3 from the base member 4 conveniently and rapidly.

Although a particular embodiment of the invention has been described in detail for purposes of illustration, various modifications and enhancements may be made without departing from the spirit and scope of the invention. Accordingly, the invention is not to be limited except as by the appended claims.

What the invention claimed is:

1. A holder stand, comprising:
a support arm assembly comprising at least one arm component, a first connector located at one end of said at least one arm component, and a second connector located at an opposite end of said at least one arm component;
a holder member pivotally connected to said first connector of said support arm and adapted to hold a mobile electronic device, said holder member comprising a plurality of corner lugs respectively located at corners of a front wall thereof for securing the loaded mobile electronic device;
a mating connection block assembly pivotally connected to said second connector of said support arm assembly, said mating connection block assembly comprising a housing, two press members and two spring members, said housing comprising an accommodation chamber defined therein for accommodating said press members and said spring members, two protruding mounting portions symmetrically located at two opposite lateral sides thereof and two openings respectively defined in two opposite sidewalls thereof corresponding to said protruding mounting portions, said spring members being transversely mounted in said accommodation chamber and aligned in line, said press member being respectively supported on said spring members, each said press member comprising a finger knob extending out of one respective said opening of said housing and a protruding block located at a bottom side relative to said finger knob; and
a base member comprising two guide rails transversely disposed at a top wall thereof, a position-limited groove defined between said two guide rails for receiving said housing of said mating connection block assembly, and a retaining hole defined in each said guide rail and facing toward said position-limited groove for receiving the protruding block of one respective said press member to secure said mating connection block assembly to said base member.

2. The holder stand as claimed in claim 1, wherein said first connector of said support arm assembly comprises a neck perpendicularly outwardly extended from the periphery thereof, and a ball located at a distal end of said neck; said holder member comprises a connector located at a back side thereof, the connector of said holder member comprising a socket for accommodating said ball of said first connector of said support arm assembly and a front socket hole defined in a front side of said socket for the passing of said neck of said first connector of said support arm assembly.

3. The holder stand as claimed in claim 1, wherein said support arm assembly further comprises a connection rod pivotally connecting said at least one arm component to said second connector, and a stop block disposed at a bottom side relative to said connection rod for stopping against said second connector; said second connector comprising a plurality of support bars vertically disposed at a top side thereof and pivotally coupled to said connection rod and a vertical cut plane located at a front side thereof for stopping against said stop block.

4. The holder stand as claimed in claim 1, wherein said second connector further comprises an axle hole transversely disposed at a middle part thereof, an axle rod mounted in said axle hole, said axle rod comprising a male screw portion suspending outside said axle hole, and two protruding stop portions bilaterally disposed at a rear side thereof for stopping against said housing of said mating connection block assembly; said mating connection block assembly comprises a through hole located at a front side of said housing for the passing of said axle rod of said second connector of said support arm assembly, and a screw nut mounted in said housing and threaded onto said male screw portion of said axle rod of said second connector of said support arm assembly.

5. The holder stand as claimed in claim 1, wherein said holder member further comprises an accommodation space defined in the front wall thereof and surrounded by said corner lugs for holding a mobile electronic device; each said corner lug defines a hook portion at a top side thereof eof for hooking on the loaded mobile electronic device.

6. The holder stand as claimed in claim 1, wherein said housing of said mating connection block assembly comprises a bottom shell, and a top cover shell covering said bottom shell; said protruding mounting portions of said housing are symmetrically located at two opposite lateral sides of said bottom shell; said openings of said housing are respectively located at two opposite sidewalls of said top cover shell.

7. The holder stand as claimed in claim 6, wherein said bottom shell of said housing comprises a plurality of partition blocks symmetrically arranged at a top wall thereof, two transverse sliding ways symmetrically defined between the partition blocks of said bottom shell and aligned in line, and two locating rods respectively disposed in the transverse sliding ways of said bottoms shell near a middle part of the top wall of said bottom shell for supporting said spring members; each said press member further comprises a body panel carrying said finger knob and stoppable at an inner surface of one respective sidewall of said top cover shell within the respective opening of said top covet shell, a plurality of guide plates perpendicularly extended from a back surface of said body panel opposite to said finger knob and slidably inserted into one respective transverse sliding way of said bottom shell and one respective sliding way of said top cover shell, and a locating hole located at the back surface of said body panel and adapted to accommodate one end of one respective said spring member.

8. The holder stand as claimed in claim 7, wherein said bottom shell of said housing further comprises a plurality of vertical countersunk holes, a plurality of mounting screws respectively mounted in said vertical countersunk holes to affix said bottom shell to said top cover shell; said top cover shell of said housing further comprises a plurality of partition plates disposed therein and respectively attached to the partition blocks of said bottom shell, two sliding ways defined between the partition plates of said top cover shell corresponding to the transverse sliding ways of said bottom shell, a plurality of mounting screw holes respectively aimed at said vertical countersunk holes of said bottom shell for receiving the respective said mounting screws.

9. The holder stand as claimed in claim 1, wherein each said press member further comprises a bevel edge located at a rear side of the protruding block thereof; said base member further comprises a stop flange located at a rear side of each said guide rail and facing toward said position-limited groove for stopping said bottom shell in said position-limited groove, and a bearing edge located at a front side of each said guide rail for stopping against the bevel edge of the respective said press member.

10. The holder stand as claimed in claim 1, wherein said base member further comprises a plurality of mounting through holes, and a plurality of fastening members for mounting in said mounting through holes of said base member to affix said base member to an external support wall.
